(19) United States
(12) Patent Application Publication
(10) Pub. No.: US 2017/0364209 A1
(43) Pub. Date: Dec. 21, 2017

(54) SYSTEM AND INTERFACES FOR AN INTERACTIVE SYSTEM

(71) Applicant: RANDORI LLC, Cambridge, MA (US)

(72) Inventor: Jonathan K. Cheng, Cambridge, MA (US)

(73) Assignee: RANDORI LLC, Cambridge, MA (US)

(21) Appl. No.: 15/693,075

(22) Filed: Aug. 31, 2017

Related U.S. Application Data
(63) Continuation-in-part of application No. 15/182,175, filed on Jun. 14, 2016.
(60) Provisional application No. 62/345,961, filed on Jun. 6, 2016.

(51) Int. Cl. G06F 3/042; A63F 13/25; A63F 13/213; G06T 7/73; G06F 3/0484

(52) U.S. Cl. CPC G06F 3/0425; G06T 7/74; G06F 3/04845; A63F 13/213; A63F 13/25; G06T 2207/10016

(57) ABSTRACT

A system is provided that is capable of storing and presenting within an interface, interactive content. For instance, it is appreciated that there may be a need to effectively present interactive content at a customer site using standard computer equipment. Also it may be beneficial to provide user tools to easily calibrate the system and customize the interactive content to suit the particular interactive content and environment. A distributed system permits the use, customization and display of interactive content among a number of various site locations.

### RELATED APPLICATIONS

This Application claims the benefit under 35 U.S.C. §120 of U.S. application Ser. No. 15/182,175, entitled “SYSTEM AND INTERFACES FOR AN INTERACTIVE SYSTEM” filed on Jun. 14, 2016, which is herein incorporated by reference in its entirety. application Ser. No. 15/182,175 claims priority under 35 U.S.C. §119(e) to U.S. Provisional Application Ser. No. 62/345,961, entitled “SYSTEM AND INTERFACES FOR AN INTERACTIVE SYSTEM” filed on Jun. 6, 2016, which is herein incorporated by reference in its entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND

Systems exist that permit users to interact with computer systems in a variety of ways. For instance, there are computer systems that permit the display of information that is projected on a screen. Many of these systems involve specialized projectors that are integrated with specialized computer systems, such as those that are used in classroom applications. For instance, there are projectors that permit use of a whiteboard area as a display, and use special pens and other elements to determine where a user is providing input (e.g., writing on a whiteboard).

### SUMMARY

It is appreciated that it would be beneficial to provide an interface that can use common components (e.g., computers, webcam and projectors) to provide an interactive system that can be used for a number of different application and settings. For instance, such a system may be supported in an ad hoc way in a public setting such as a climbing gym, a museum, an auditorium, or other forum that can support an ad hoc activity. Existing systems and software tools are not sufficient to support such displays in an ad hoc manner, as they require expensive equipment that requires professional installation and setup. Further, it is appreciated that such ad hoc uses cannot justify such expensive systems.

What is needed is a system and associated interfaces that permit users to create an interactive system in an ad hoc way using conventional components, such as a webcam, a standard projector and computer system. In particular, a standard projector may be coupled to a typical computer with a camera, which is coupled to a communication network. Specialized software may be provided that permits the computer to display interactive content on a surface, and the camera of the computer system is capable of capturing video that can be used by the computer system to detect interactions (e.g., human interaction) with the displayed interactive content. Because these systems are decoupled (e.g., the projector is not integrated with the camera), tools may be provided that allow the user to easily calibrate the system.

For instance, it is appreciated that there may be provided a user interface that permits the user to define an interactive area within a computer interface that displays captured video of a surface or other shape or element of a location. For instance, a standard climbing wall may be transformed into an interactive game area. In another example, an augmented reality game may be provided in a gym, yoga studio, etc. that includes interactive elements displayed within the location. Other areas, such as museums, trampoline parks, shopping centers, airports, or other locations may be used to present interactive content by such a system.

In one embodiment, a tool is provided that allows the user to indicate, to the computer system, a definition of an interactive area within an area captured by the camera. At least a portion of the interactive area overlaps a display area of the projector display area, and interactions with elements that are displayed in the interactive area are captured by the camera. According to one embodiment, the system provides an editing environment for designing interactive content. In particular, the interface permits creation of the interactive content at a customer site using conventional computer elements and projectors, and the interactive content is hosted at a central location (e.g., in the cloud). Further, a distributed system permits the use, customization and display of interactive content among a number of various site locations. Users may subscribe to interactive content using standard, user-supplied equipment to create and display interactive content. In another implementation, a kit is provided that provides a camera, projector, and downloaded software that can be set up for use at a particular customer site.

According to another aspect of the present invention, a system is provided that combines an interface for projection mapping along with a method for performing motion capture for use as an interactive system. In one embodiment, the projection mapping provides the interface and configuration that permits the user to adapt the interface to conform to a particular surface (e.g., a wall). The interface allows the user to change a geometry of motion captured areas within the interface.

According to another aspect of the present invention, a system is provided that displays interactive elements on a display surface. The system automatically determines and labels locations of the interactive elements in images of the display surface in order to align the system with the interactive elements. According to one embodiment, the system captures one image of the display surface without any interactive elements displayed and then captures another image of the display surface with a selected interactive element displayed. The system then compares the two images to identify a location of the selected interactive element in the captured image. The system can then label the interactive element and use the labeled location to detect user interactions with the interactive element. In some embodiments, the system can be configured to execute alignment responsive to a user input (e.g., a click, touch, entry, selection, or other input). Additionally and/or alternatively, the system can be configured to align interactive elements that are added and/or generated during an interactive session (e.g., during an interactive game session).

According to another aspect of the present invention, a system is provided that can automatically detect user interactions with interactive elements displayed on a surface. The system can be configured to use image information captured from an image capture device (e.g., a camera) to detect user interactions. In some embodiments, the system can be configured to execute various functions associated with an interactive application responsive to detecting user interactions. For example, the interactive application can comprise an interactive game, interactive education application, interactive entertainment system, and/or other interactive application. The system can be configured to trigger actions in response to detecting user interactions. For example, the system can execute game scoring activities, generate animations, generate additional interactive elements, or execute other actions associated with the interactive application.

According to some embodiments, during execution of an interactive application the system can capture and process image frames of a display surface to detect user interactions with interactive elements. The system can compare image frames captured over time at labeled locations of the interactive elements to detect user interactions with the interactive elements. In one embodiment, the system can be configured to compare only pixel values for locations within the images corresponding to locations of the interactive elements. The inventors have appreciated that reducing computations by comparing images at only the labeled locations of the interactive elements significantly increases processing efficiency and enables detections of user interactions in real time.

According to one aspect of the present invention, a system is provided comprising a projector, a camera, and a computer system coupled to the processor, the computer system comprising at least one processor operatively connected to a memory, the at least one processor, when executing is configured to operate the projector to display interactive content on a surface, operate the camera to capture at least image of the displayed interactive content, and an alignment tool adapted to align a component within the captured at least one image and a computer-generated representation of the interactive content. According to one embodiment, the at least one processor is further configured to store alignment information in the memory.

According to another embodiment, the at least one processor is further configured to present, within a display of the computer, an editor interface including a control that permits a user to associate an interactive element with the component within the display. According to another embodiment, the system further comprises at least one user interface control that when selected, permits a user to select an interactive element and position the element over a captured aspect of a real-world element, and that causes the at least one user interface to project the element over the real-world element.

According to another embodiment, the camera is adapted to capture a real-world interaction with the projected element. According to another embodiment, the real-world element is a climbing element within a climbing course. According to another embodiment, the system further comprises at least one control that permits the user to define behavior of the interactive element within the display.

According to another embodiment, the behavior comprises visual appearance of the interactive element. According to another embodiment, the at least one processor is further configured to present, within a display of the computer, one or more controls that permit a user to adjust image processing behavior.

According to another embodiment, the one or more controls comprises at least one control adapted to change sensitivity to a real-world action that triggers a selection of a projected interactive element. According to another embodiment, the one or more controls comprises at least one control adapted to adjust a lighting control for adjusting parameters relating to processing captured images at a particular site location.

According to another aspect of the present invention, in a system comprising a projector, camera and computer system, a method comprising operating the projector to display interactive content on a surface, operating the camera to capture at least image of the displayed interactive content, and aligning, by an alignment tool provided by the computer system, a component within the captured at least one image and a computer-generated representation of the interactive content. According to one embodiment, the method further comprises an act of storing, in a memory of the computer system, alignment information.

According to another embodiment, the method further comprises an act of displaying, within a display of the computer, an editor interface including a control that permits a user to associate an interactive element with the component within the display. According to another embodiment, the method further comprises an act of permitting a user, via at least one user interface control that when selected by the user, to select an interactive element and position the element over a captured aspect of a real-world element, and in response, causing the at least one user interface to project the element over the real-world element. According to another embodiment, the method further comprises an act of capturing a real-world interaction with the projected element.

According to another embodiment, the real-world element is a climbing element within a climbing course. According to another embodiment, the method further comprises an act of permitting a user, via at least one control, to define behavior of the interactive element within the display. According to another embodiment, the behavior comprises visual appearance of the interactive element.

According to another embodiment, the method further comprises an act of presenting, within a display of the computer, one or more controls that permit a user to adjust image processing behavior. According to another embodiment, the one or more controls comprises at least one control adapted to change sensitivity to a real-world action that triggers a selection of a projected interactive element. According to another embodiment, the one or more controls comprises at least one control adapted to adjust a lighting control for adjusting parameters relating to processing captured images at a particular site location.

According to another aspect of the present invention, a non-volatile computer-readable medium encoded with instructions for execution on a computer system. The instructions when executed, provide a system comprising a projector, a camera, and a computer system coupled to the processor, the computer system comprising at least one processor operatively connected to a memory, the at least one processor, when executing is configured to operate the projector to display interactive content on a surface, operate the camera to capture at least image of the displayed interactive content, an alignment tool adapted to align a component within the captured at least one image and a computer-generated representation of the interactive content.

According to one aspect, a system is provided. The system comprises a projector; a camera; and at least one processor operatively connected to a memory, the at least one processor configured to execute a plurality of system components from the memory, wherein the plurality of system components comprise: a display component configured to operate the projector to display interactive content on a surface, the interactive content including one or more interactive elements; a motion capture component configured to operate the camera to capture at least one image of the interactive content displayed by the projector; an alignment component configured to automatically determine and label locations of the one or more interactive elements in the at least one image of the displayed interactive content; and a logic management component configured to detect a user interaction with at least one interactive element of the one or more interactive elements.

According to one embodiment, the alignment component is further configured to: select an interactive element of the one or more interactive elements; capture a first image, the first image comprising an image of the interactive content without the one or more interactive elements; capture a second image, the second image comprising an image of the interactive content including only the selected interactive element; and determine, using the first and second images, a location of the selected interactive element. According to another embodiment, the alignment component is further configured to: determine a difference between the first image and the second image; identify a location where the difference exceeds a threshold; and label the identified location as the location of the selected interactive element. According to another embodiment, the alignment component is further configured to determine a difference between pixel values of the first image and the second image to determine the difference.

According to one embodiment, the alignment component is further configured to define a window around a respective location of the at least one interactive element. According to another embodiment, the alignment component is further configured to define a set of pixels of a captured image as the window. According to another embodiment, the at least one image includes a plurality of video frames including a first video frame and a second video frame and the motion capture component is further configured to determine, within the defined window, whether a difference between the first video frame and the second video frame exceeds a threshold.

According to one embodiment, the logic management component is configured to: associate an action with the at least one interactive element; activate the at least one interactive element; and command execution of the associated action responsive to the activation. According to another embodiment, the logic management component is further configured to activate the at least one interactive element responsive to detecting that the difference between the first video frame and the second video frame exceeds the threshold within the defined window. According to another embodiment, the plurality of system components further includes a control component configured to: receive a sensitivity input; and set the threshold according to the sensitivity input.

According to one aspect, a method implemented in a system comprising a projector, a camera, and a computer system is provided. The method comprises operating the projector to display interactive content on a surface, the interactive content including one or more interactive elements; operating the camera to capture at least one image of the interactive content displayed by the projector; automatically determining and labeling, by the computer system, locations of the one or more interactive elements in the at least one image of the displayed interactive content; and detecting a user interaction with at least one interactive element of the one or more interactive elements.

According to one embodiment, the method further comprises selecting an interactive element of the one or more interactive elements; capturing a first image, the first image comprising an image of the interactive content without the one or more interactive elements; capturing a second image, the second image comprising an image of the interactive content including only the selected interactive element; and determining, using the first and second images, a location of the selected interactive element. According to another embodiment, the method further comprises determining a difference between the first image and the second image; identifying a location where the difference exceeds a threshold; and labeling the identified location as the location of the selected interactive element. According to another embodiment, the method further comprises determining a difference between pixel values of the first image and the second image to determine the difference.

According to one embodiment, the method further comprises defining a window around a respective location of the least one interactive element of the one or more interactive elements. According to another embodiment, the method further comprises defining a set of pixels of a captured image as the window. According to another embodiment, capturing the at least one image includes capturing a plurality of video frames including a first video frame and a second video frame and the method further comprises determining, within the defined window, whether a difference between the first video frame and the second video frame exceeds a threshold. According to another embodiment, the method further comprises associating an action with the at least one interactive element; activating the at least one interactive element; and commanding execution of the associated action responsive to the activation. According to another embodiment, the method further comprises activating the at least one interactive element responsive to detecting that the difference between the first video frame and the second video frame exceeds the threshold within the defined window. According to another embodiment, the method further comprises receiving a sensitivity input; and setting the threshold according to the sensitivity input.

According to one aspect, a non-volatile computer-readable medium encoded with instructions for execution on a computer system is provided. The instructions, when executed, perform a method comprising: operating a projector to display interactive content on a surface, the interactive content including one or more interactive elements; operating a camera to capture at least one image of the interactive content displayed by the projector; automatically determining and labeling locations of the one or more interactive elements in the at least one image of the displayed interactive content; and detecting a user interaction with at least one interactive element of the one or more interactive elements.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “ this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 shows a block diagram of a distributed computer system capable of implementing various aspects of the present invention;

FIG. 2 shows an example process for presenting interactive content according to one embodiment of the present invention;

FIG. 3 shows an example process for calibrating an interactive system according to one embodiment of the present invention;

FIG. 4 shows another example process for calibrating an interactive system according to one embodiment of the present invention;

FIG. 5 shows an example process for designing a game using an interactive system according to one embodiment of the present invention;

FIG. 6 shows an example user interface according to various embodiments of the present invention;

FIG. 7 shows an example user interface with various user controls according to various embodiments of the present invention;

FIG. 8 shows an example user interface used to design an interactive game according to various embodiments of the present invention;

FIG. 9 shows an example user interface used to present an interactive game according to various embodiments of the present invention;

FIG. 10 shows an example user interface that shows an interactive game element according to various embodiments of the present invention;

FIG. 11 is a block diagram of a system capable of implementing various aspects of the present invention;

FIG. 12 shows an example of manual user alignment according to various embodiments of the present invention;

FIG. 13 shows an example process for automatically calibrating an interactive system according to one embodiment of the present invention;

FIG. 14 shows an example of automatically calibrating an interactive system according to one embodiment of the present invention;

FIG. 15 shows an example process for detecting user interaction in an interactive system according to one embodiment of the present invention;

FIG. 16 shows an example of detecting user interaction in an interactive system according to one embodiment of the present invention; and

FIG. 17 is a schematic diagram of an exemplary computer system that may be specially configured to perform processes and functions discloses herein.

### DETAILED DESCRIPTION

According to one implementation, a system is provided that is capable of storing and presenting within an interface, interactive content. For instance, it is appreciated that there may be a need to effectively provide interactive content at a customer site using standard computer equipment. Also it may be beneficial to provide user tools to easily calibrate the system and customize the interactive content to suit the particular content. Typical interactive systems generally require expensive, customized hardware that is installed by professional technicians.

According to some embodiments, an interactive system that includes a projector, image capture device (e.g., a camera), and a device (e.g., a computer, laptop, smartphone) is provided. The device may operate the projector to display interactive content on a surface. The interactive content may include one or more interactive elements of an application. For example, the interactive content can include visual components of a game or interactive education application displayed on the display surface. When a user interacts with the interactive elements, the application may be configured to respond according to the interaction. For example, a user interaction can trigger scoring in a game, animation in an educational application, or other action.

In some embodiments, the device can further operate the camera to capture an image(s) of the display surface. In some embodiments, the device may be configured to automatically determine and label locations of one or more interactive elements in images of the interactive content. For example, the device may determine locations (e.g., pixel locations, pixel windows) of interactive elements within an image of a display surface. The device can be configured to label determined locations within the image. For example, the device may label windows of pixels corresponding to interactive elements in a captured image(s).

In some embodiments, the device may further be configured to automatically detect a user interaction with an interactive element(s). The device may operate the camera to capture images of interactive content shown on the display surface. The device may use the captured images to detect user interactions with interactive elements. In some embodiments, the device can be configured to look for user interactions at locations within the captured images corresponding to the interactive elements. For example, the device can be configured to identify changes in pixel values at locations within a sequence of captured images corresponding to the interactive elements. The inventors have appreciated that detecting user interactions by analyzing specific labeled portions of collected images significantly increases computation efficiency and allows real time detection of user interactions with no apparent delay.

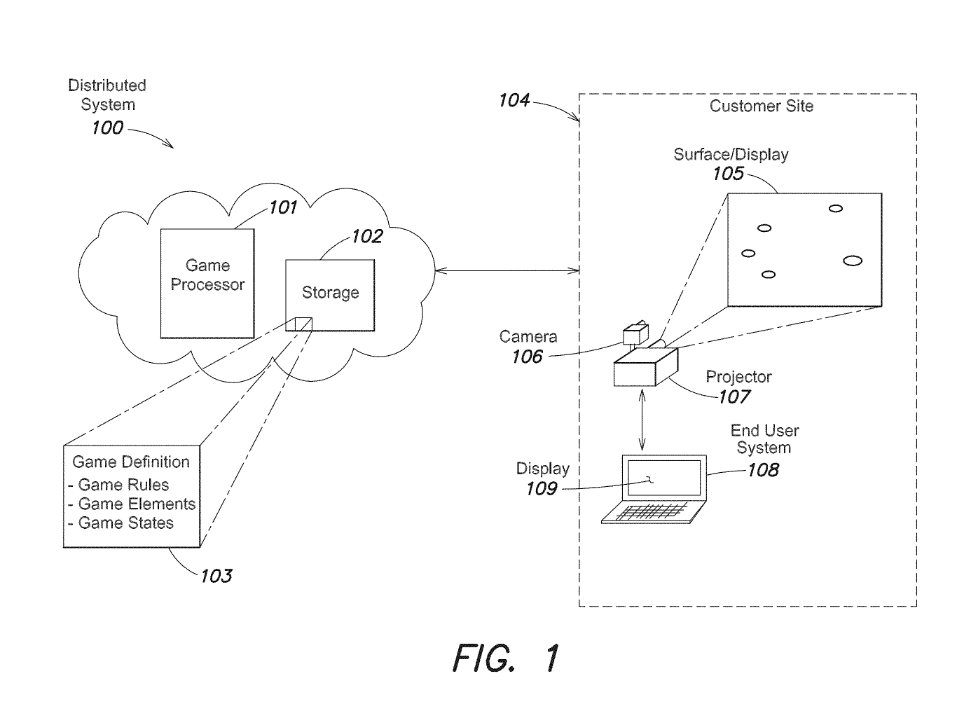

FIG. 1 shows a block diagram of a distributed computer system 100 capable of implementing various aspects of the present invention. In particular, distributed system 100 includes one or more computer systems operated by a user and a virtualized game system that is accessed by the computer system through a communication network (e.g., the Internet). Generally, users may access the distributed system through a client application that is executed on one or more of end systems (e.g., end user system 108). End user systems 108 may be, for example, a desktop computer system, mobile device, tablet or any other computer system having a display.

As discussed, various aspects of the present invention relate to interfaces through which the user can interact with interactive content system. To this end, users may access the interactive content system via the end user system (e.g., system 108) and/or one or more real-world interactive interfaces provided by the computer system via a projector (e.g., projector 107) and a camera (e.g., camera 106).

According to one embodiment, the projector 107 displays computer generated content on the surface/display 105. For instance, the surface may be a flat surface such as a wall, screen, or other element displayed within the real world. Camera 106 may be used to collect video information relating to any interaction with the displayed computer generated content provided by the projector. Based on video information collected by the camera, the computer (e.g., end-user system 108) may detect the interaction and provide revised content to be displayed to the user via the projector. In this way, a user may interact with the interactive content system using only the surface/display 105.

To this end, within the display, may be provided one or more interactive elements that can be selected and/or manipulated by the user. Such interactive elements may be, for example, game elements associated with a computer game. To accomplish this, distributed system 100 may include a game processor 101, storage 102, and one or more game definitions 103. Game processor 101 may include one or more hardware processors that execute game logic, store game states, and communicate with end-user systems for the purpose of executing a game program at a customer site (e.g., customer site 104).

The game definition may be provided, for example, by an entity that maintains a game server. For instance, the game may be a real-world climbing game conducted at a climbing gym including a number of real world climbing elements along with virtual interactive elements that may be activated by participants in the climbing game. Although it should be appreciated that any of the aspects described herein can be implemented in the climbing game, it should be appreciated that aspects may be implemented in other environments that have real-world features, such as, for example, museums, gyms, public displays, or any other location that can benefit from real-world interactive content.

The game definition may include one or more game rules involving one or more game elements (e.g., information that identifies elements that can be displayed and interacted with within the real world). Storage 102 may also include other information such as game state information that identifies a current game state of a particular game instance. In one embodiment, the system is implemented on a cloud-based system wherein multiple sites may communicate to the game server system and service. In one embodiment, software may be downloadable to a conventional computer system using a conventional web camera and standard projector, allowing a typical end-user to create an interactive system without needing specialized hardware. The software may include components that access the camera and output information on the projector and coordinate the detection of movement in relation to the information displayed by the computer via the projector.

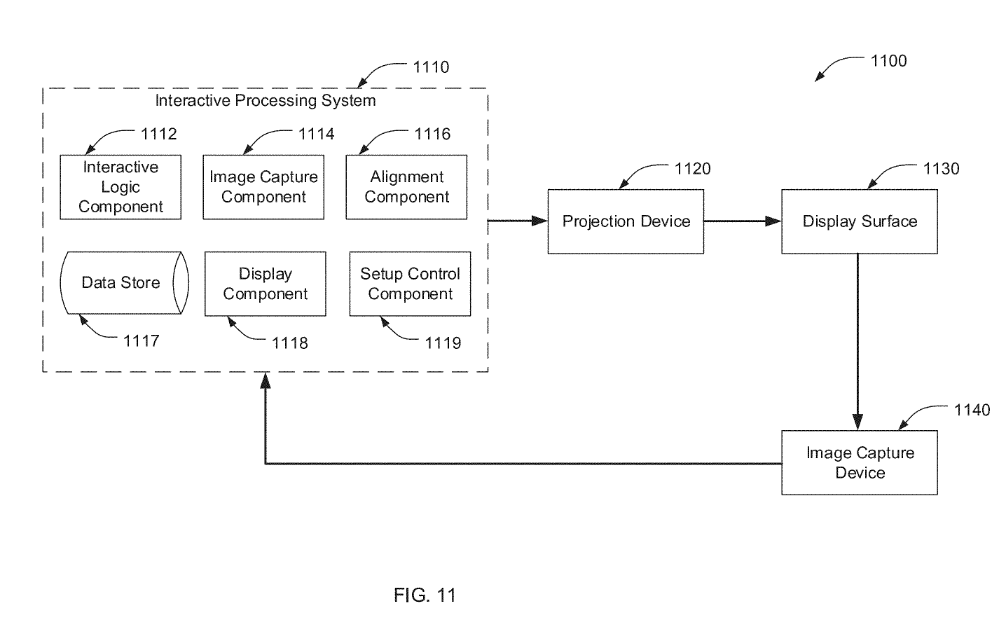

FIG. 11 illustrates an exemplary system 1100 according to various aspects of the present invention. System 1100 may include an interactive processing system 1110 that can be configured to generate and output display information to a projection device 1120 (e.g., projector 107). The projection device 1120 may generate a display surface 1130 (e.g., display 105). For example, the display component 1118 may generate a particular display on a device (e.g., system 108) which may be projected by projection device 1120 onto display surface 1130. An image capture device 1140 (e.g., camera 106) may capture image and/or video information from the display surface 1130 and transmit it to interactive processing system 1110. The interactive processing system 1110 may use the received image capture device 1140 information to execute various processes in accordance with embodiments of the present invention. Note that the system 1100 can be configured to execute other processes in addition to and/or outside of the processes described herein.

According to one embodiment, the interactive processing system 1110 may include an interactive logic component 1112. The interactive logic component 1112 may be configured to determine and execute various actions according to logic and rules for a particular interactive application (e.g., interactive game or education activity). The interactive logic component 1112 may communicate with various other components of the interacting processing system 1110 in order to carry out actions according to the logic and rules of the interactive application. In some embodiments, the interactive logic component may communicate with a display component 1118 in order to generate particular displays (e.g., animations, backgrounds, pictures, and other displays). The interactive logic component 1112 may, for example, communicate with the display component 1118 in order to animate one or more interactive elements associated with the interactive application.

In some embodiments, the interactive logic component 1112 may receive information from an image capture component 1114. The image capture component 1114 may process input received from image capture device 1140. The interactive logic component 1112 may utilize information generated from the processing executed by image capture component 1140 as inputs to functions associated with the interactive application. The interactive logic component 1112 may, for example, trigger particular actions (e.g., animations, game scoring, other programmed actions) in response to detection of changes between video frames received from image capture component 1114.

In one implementation, the interactive application may comprise a game. The game may have a definition (e.g., game definition 103) which includes various rules, game elements, and game states. The interactive logic component 1112 may manage execution of various actions according to the game rules and states. In one embodiment, the interactive logic component 1112 may receive information about user interaction with the display surface 1130 from the image capture component 1114. The image capture component 1114 may receive input images (e.g., photos, video frames) and process them to detect particular interactions (e.g., movements, touches). The image capture component 1114 may communicate detection information to the interactive logic component 1112. The interactive logic component 1112 may communicate with the display component 1118 to execute particular actions (e.g., animations and/or scoring) associated with the game in response to detections.

In one example, the game may be set up on a climbing wall and the interactive elements may comprise particular locations on the climbing wall where a user interaction may trigger particular game states or rules (e.g., scoring) and may further trigger an associated animation. The image capture component 1140 may analyze video frames of the climbing wall and detect changes between video frame captures of the climbing wall. The interactive logic component 1112 may receive information indicating the detections and, in response, trigger actions. The interactive logic component 1112 may, for example, add to a score and/or command the display component 1118 to generate a particular animation. A display of the animation may then be projected by projection device 1120 onto the climbing wall display surface 1130.

In some embodiments, the interactive processing system 1110 may further include an alignment component 1116. The alignment component 1116 may be configured to align programmed representations of interactive elements with displayed interactive elements. In one implementation, an interactive application may include various interactive elements that are displayed by projection device 1120 (e.g., a projector) onto display surface 1130. The image capture component 1114 may need to recognize a location of the interactive elements within an image received from image capture device 1140 (e.g., a camera). The image capture component 1114 may, in one implementation, view a received image as a grid of pixels and may need to identify a location of the interactive elements within the grid. The image capture component 1114 may utilize the determined locations to detect changes between images at or near the locations during execution of the interactive application.

In some embodiments, the alignment component 1116 may align the displayed interactive elements with programmed representations of interactive elements using user input. In one implementation, the alignment component 1116 may generate a user interface allowing a user to label a representation of interactive elements within an image of the display surface 1130 received from image capture device 1140.

In some embodiments, the alignment component 1116 may align programmed representations of interactive elements with displayed interactive elements automatically. In one implementation, the alignment component 1116 may communicate with the display component 1118 to generate a display without any interactive elements shown and successive displays showing individual ones of the interactive elements. The alignment component 1116 may then compare the displays showing individual ones of the interactive elements to the display without any interactive elements shown to identify locations of the interactive elements within the images. Automatic alignment methods according to embodiments of the present invention are discussed in further detail below.

In some embodiments, the alignment component 1116 may further label the identified locations. In one implementation, the alignment component 1116 may define a window around the determined location. The window may define a region within a received image where the image capture component 1114 may detect changes that correspond to interactions with an interactive element associated with the region within the received image.

In one example, the interactive application may comprise an interactive wall climbing game. In this example, the interactive elements of the game may comprise particular regions on a climbing wall where motion within the regions can trigger particular game actions. Image capture component 1114 may be aligned with the climbing wall such that it is aware of locations of the interactive elements within images of the climbing wall received from a camera 1140. For example, the image capture component 1114 may need to know of particular pixels within received images that correspond to interactive elements of the wall climbing game. In one example, the alignment component 1116 may generate a user interface through which it can receive user input specifying the locations of the interactive game elements. In another example, the alignment component 1116 may communicate with display component 1118 to product displays without the interactive elements shown and with individual elements shown. The alignment component 1116 may use the images to identify locations of the interactive elements. Furthermore, using the determined locations, the alignment component 1116 may define windows around the locations specifying particular areas within received images at which the image capture component 1114 may detect user interactions. The areas within the received images may correspond to the regions on the climbing wall where motion triggers particular game actions.

In some embodiments, the interactive processing system 1110 may further include a setup control component 1119. The setup control component 1119 may receive information to set control parameters within the interactive processing system. In one implementation, the setup control component 1119 may receive user input specifying sensitivity of interactive elements within an interactive application. In some embodiments, the sensitivity may control how easily an interaction with an interactive element is detected by the interactive processing system 1110. The sensitivity input may, for example, control a threshold at which an interaction is detected. For example, the threshold may comprise a limit of difference between pixels of images or video frames. A higher sensitivity may correspond to a lower threshold and a lower sensitivity may correspond to a higher threshold. In some embodiments, the setup control component 1119 may generate a user interface that allows a user to modify a sensitivity input (e.g., a variable bar).

In some embodiments, the setup control component 1119 may further receive input specifying a level of lighting. The lighting may, for example, affect operation of various aspects of the game and affect users' ability to view a projected display on surface 1130. In one implementation, the setup control component 1119 generates a user interface through which it may receive user input specifying lighting. The user interface may, for example, include a bar and handle that a user may drag to control the lighting control parameter.

In some embodiments, the setup control component 1119 may further generate a user interface through which users may setup and customize interactive applications. The setup control component 1119 may, for example, generate a user interface via which a user may drag interactive elements onto a display. The user may further specify particular actions for the interactive application via the user interface. The interactive processing system 1110 may utilize inputs received from the users to define logic and parameters used by the interactive logic component 1112 during execution of an interactive application.

In some embodiments, the interactive processing system 1110 may further include a data store 1117 (e.g., a database). The interactive processing system 1110 may store particular settings (e.g., control parameters, element locations) for an interactive application in the data store 1117. A user may later retrieve the settings to set up an interactive application that was previous executed. Additionally, the interactive processing system 1110 may store interactive application definitions, rules, logic, and other interactive application information in the data store. The interactive processing system 1110 may read and utilize relevant information for each interactive application. It is appreciated that system 1100 may be used in a variety of environments and applications. The interactive processing system 1110 may use the data store 1117 to store information necessary to recreate an operating environment for each application (e.g., displays, interactive elements, user interfaces, animations).

In some embodiments, various components of interactive processing system 1110 may execute on an end user system (e.g., system 108). In other embodiments, various components may execute outside of the end user system. For example, some or all components may execute on a server and communicate over a network with end user system 108. For example, some or all components may execute on processor 101 with storage 102 discussed above with respect to FIG. 1. Embodiments of the present invention are not limited in this respect.

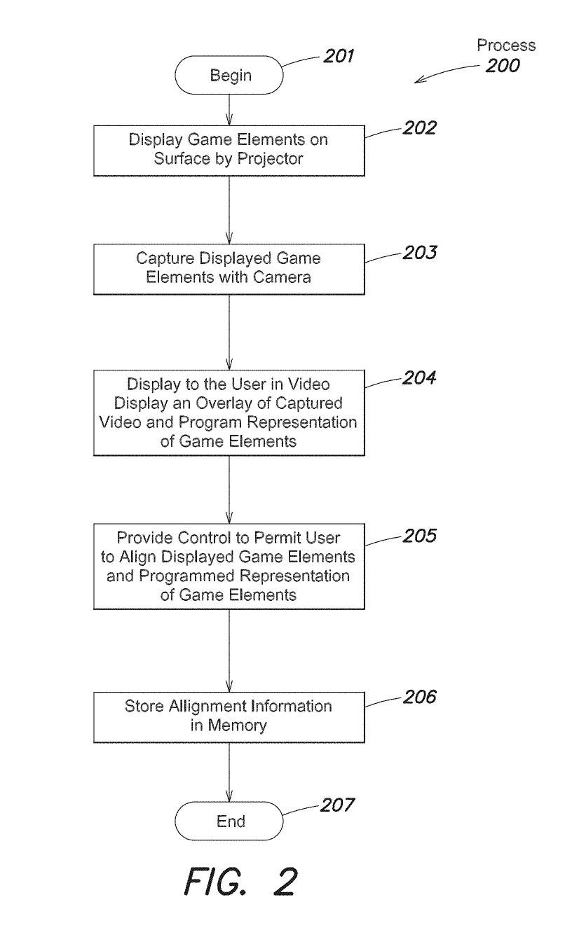

FIG. 2 shows an example process 200 for presenting interactive content according to one embodiment of the present invention. At block 201, process 200 begins. At block 202, game elements are displayed on a surface by the projector. For instance, one or more game elements may be arranged on an interface by a user of the computer system, in these game elements are displayed on predefined locations in relation to an image that is displayed by the projector on the surface (e.g., a wall).

At block 203, the system captures the displayed game elements with a camera (e.g., a web cam coupled to the computer system). At block 204, the system displays to the user in the video display and overlay of the captured video and a programmable representation of game elements. For instance, the system may include a representation of the captured video along with a logical representation of the area in which interactive game elements are placed. This may be accomplished by, for example, overlaying graphical elements on a representation of the captured video.

At block 205, the system may provide a control to the user that permits the user to align displayed game elements and a programmed representation of the game elements. For example, if there are one or more real-world game elements, these elements may be captured by the camera and the user may be able to align virtual game elements with the captured representation. In one example, the user is allowed to define a field (e.g., by a rectangle or other shape) in which interactive elements may be placed. Further, interactive virtual game elements may be aligned with actual real-world game elements. In the case of a climbing wall game, hold locations (e.g., real-world game elements) may be aligned to interactive game elements (e.g., an achievement that can be activated by a user within the real world).

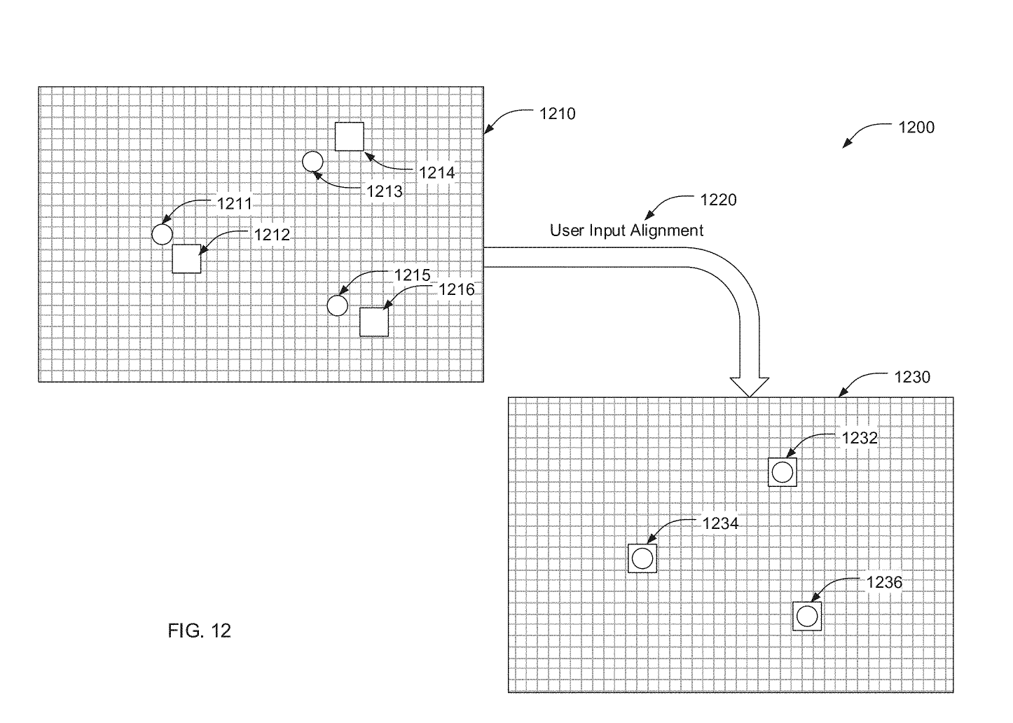

FIG. 12 illustrates an example process of aligning displayed elements and programmed representation of elements. The alignment illustration may, for example, occur during step 205 of process 200 discussed above. The image 1210 may represent a video display captured and displayed to a user in a user interface with program representations of elements 1211, 1213, 1215 overlaid on the captured video. In some embodiments, the interactive processing system 1100 may represent the images captured from the video display as a grid of pixels in order for a user to align displayed elements 1211, 1213, 1215 with associated programmed representation of game elements 1212, 1214, 1216. In one embodiment, the programmed representations of game elements may comprise particular pixels or windows of pixels within video frame images that correspond to the displayed game elements.

At 1220, the interactive processing system may receive user input specifying alignment of the programmed representations of elements 1212, 1214, 1216 with respective displayed elements 1211, 1213, 1215. The interactive processing system may, for example, receive the user input in step 205 of process 200 discussed above. The image 1230 illustrates the alignment of the interactive processing system's programmed representation of elements with the displayed elements as shown by 1232, 1234, 1236. Using the user input, the interactive processing system has aligned the programmed representations with displayed elements. In one embodiment, the interactive processing system defines windows 1232, 1234, 1236 that represent the displayed elements. The interactive processing system may analyze these particular locations or windows within images of interactive display content during execution of the interactive application (e.g., game) to detect user interactions.

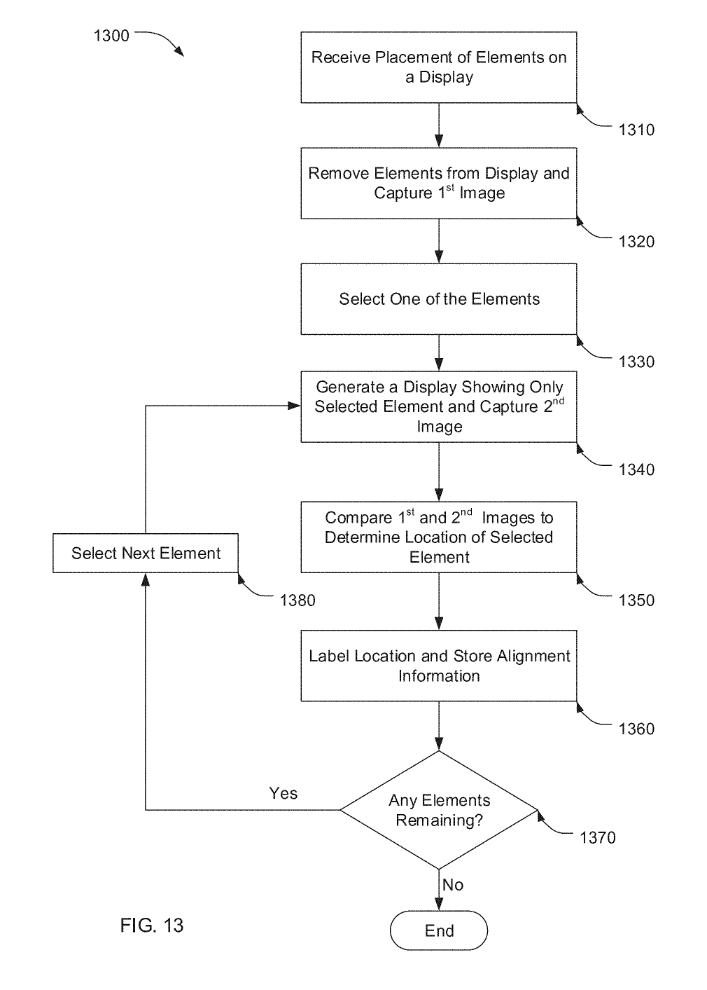

FIG. 13 shows an example process 1300 for automatically aligning displayed interactive elements with programmed representations of game elements (e.g., windows of pixels in an image of the display surface). In some embodiments, process 1300 may be executed during a setup phase of an interactive application (e.g., an interactive game). In some embodiments, process 1300 may initiate responsive to detection of a trigger input. For example, process 1300 may initiate responsive to a user input such as a click, touch, keyboard entry, user selection or other user input. In another example, the user may navigate to a particular application screen or webpage in order to trigger the process 1300. In some embodiments, the process 1300 may be executed during the course of an interactive session (e.g., during an interactive game). For example, a user may add additional elements during an interactive session or additional elements may be generated automatically during an interactive session. Process 1300 may execute responsive to additions and/or removals of interactive elements. Additionally or alternatively, process 1300 may execute responsive to a user input (e.g., click, touch, keyboard entry, user selection) during an interactive session.

Process 1300 begins at block 1310 where the system (e.g., system 1100 and/or 104) receives a placement of elements on a display. In one implementation, the system may receive a placement of elements via a user device (e.g., end user system 108) within a display during an interactive application setup process (e.g., process 500). In some embodiments, the placement of elements may be received by interactive processing system 1110 described in reference to FIG. 11 above.

Next, process 1300 proceeds to step 1320 where the system removes all the placed elements from the interactive application display and captures a first image. In some embodiments, the system may generate an identical application display without any interactive elements overlaid on the interactive application display. The system may then capture a first image of the interactive application display without any interactive elements displayed. Note that other parts of the interactive application display may still be present in the first image outside of the interactive elements. In some embodiments, a projection device (e.g., a projector) may project the generated display without any interactive elements onto a surface. An image capture device (e.g., a camera) may then capture the first image.

In one example, the interactive application may comprise an interactive climbing game. The system may generate a game display and project it onto a climbing wall (i.e. the display surface). The interactive elements may comprise particular marked locations on the climbing wall where a user interaction will trigger various aspects of the game. The locations may be marked as a colored shape for example. In one implementation, a user movement at locations on the climbing wall may cause a score increase, animation effect, and/or other effect. During step 1320 of process 1300, the system may remove the marked elements from the display and capture an image of the display with the removed elements as the first image. The system may, for example, store an image captured by a camera.

Next, exemplary process 1300 proceeds to act 1330 where one of the interactive elements is selected. The system may have detected a plurality of elements placed in the interactive application display. The system may select one of the elements randomly, in a particular order, or in any other fashion. Next, exemplary process 1300 proceeds to act 1340 where the system generates a second display showing the interactive application display with only the selected element shown. In the example of an interactive wall climbing game, the system may select one of the marked locations on the climbing wall that comprises one of the interactive elements. The system may then generate a display of the climbing wall without any marked locations except the one corresponding to the selected interactive element. The system may then capture the generated image as the second image. The system may, for example, store an image captured by a camera.

Next, exemplary process 1300 proceeds to act 1350 where the system compares the first and second captured images to determine a location of the selected element within the display. An image may comprise a plurality of pixels that represent parts of the overall image. Each pixel may be represented by one or more component values such as a red color value, green color value, and/or blue color value (RGB). Each pixel may also have a location (e.g., coordinates) within an image. In some embodiments, the system compares pixel values between the two images to determine a location where the pixel values indicate a difference.

In one implementation, the system may view each image as a grid of pixels. The system may, for example, identify pixel locations by coordinates in the image. Each pixel may, for example, have values associated with it that define the appearance of the pixel on the display (e.g., RGB values). The first and second images may be substantially similar in terms of pixel values with the exception of pixels at locations corresponding to the element. The system may calculate a difference between corresponding pixels of both images and identify where, in the grid, the images differ. The system may identify one or more pixels where the images differ as locations of the interactive elements within an image(s) of the interactive application display. In one implementation, the system may identify pixel locations where differences between the images exceed a particular threshold as the locations of the interactive elements within an image(s) of the interactive application display. In some embodiments, the threshold may be adjustable. In one implementation, the threshold may be set according to a user selected setting of sensitivity.

In the example of the interactive climbing game, the first image may show an image of the wall without any elements placed and the second image may show one element placed. A comparison between the first two images may then reveal differences in pixel values for pixels at or within a proximity of the location of the element in the second image. In some embodiments, the system may identify the location by identifying the pixels where the difference between the images exceeds a particular threshold (e.g., RGB value threshold).

Next, exemplary process 1300 proceeds to act 1360 where the system labels the identified location and stores alignment information for use in the interactive application. In one embodiment, the system may store location(s) for one or more pixels identified as corresponding to the selected element. The location(s) may, for example, comprise coordinates of pixels within a grid of pixels that make up an image of the interactive application display. In some embodiments, the system may define a window around the identified locations to define an interactive element. The window may comprise a range of pixel locations around one or more identified element pixel locations. For example, if pixel locations are designated by coordinates and an element location is identified at pixel with coordinates (5,5), a window may be defined to cover pixels with coordinates in the following combination of ranges (3-7, 3-7). In the example of an interactive climbing wall, the system may define a window that covers an entire displayed interactive element to ensure that a user interaction is detected at all portions of the displayed interactive element.

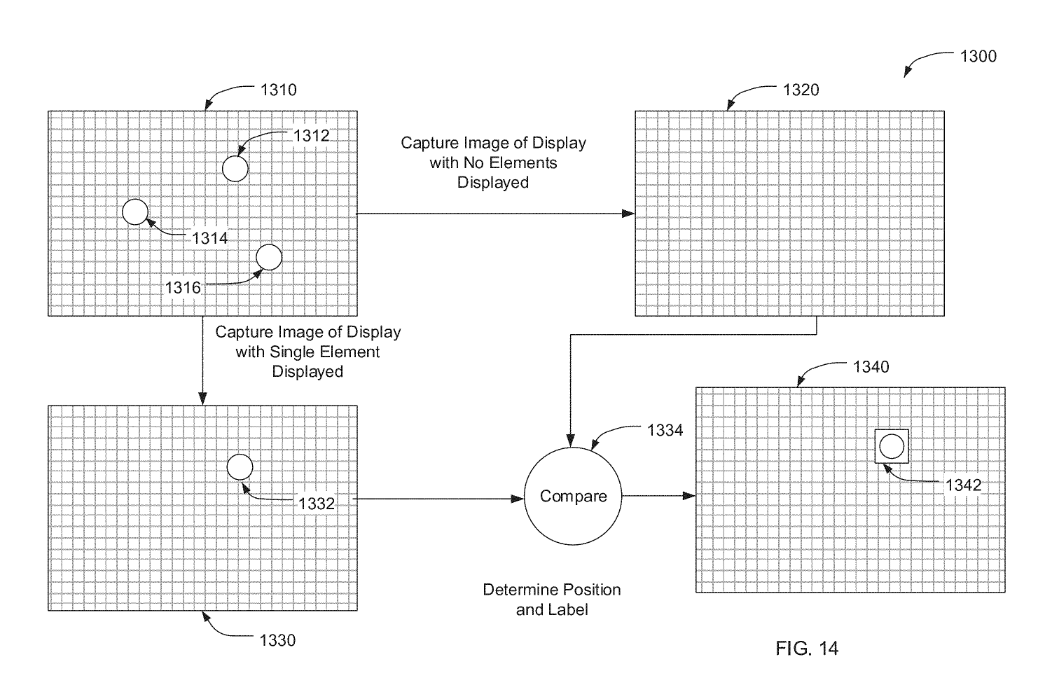

FIG. 14 illustrates an example process for capturing and comparing the first and second images to identify and/or label a location of an element placed in an interactive application display. The system may receive a display 1310 of an interactive application that includes one or more interactive elements 1312, 1314, 1316. The system may receive an image of the display captured by a camera. The elements may be placed by a user during an interactive application setup or design as described above. The system may capture an image of the display with no elements displayed 1320. The system may also select one of the placed elements 1312, generate a display in which the other elements 1314, 1316 are not shown, and capture an image 1330 showing only the selected element 1332. In some embodiments, each of the captured images may be represented by the system (e.g., interactive processing system 1110) as a grid of pixels.

Next, the system may compare 1334 the image without any elements displayed 1320 and the image with the selected interactive element displayed. The system may calculate a difference between corresponding pixels of images 1334 and 1320 to identify where in the grid the images differ. The system may identify the location of interactive display element 1332 as a location where there is a difference between images 1330 and 1320 (e.g., by detecting a threshold difference in pixel values at the location). Upon identifying the location, the system labels the location and stores the alignment information (e.g., by defining a window of pixels around the location).

After identifying and labeling a selected interactive element, exemplary process 1300 proceeds to act 1370, where the system determines whether there are any interactive elements remaining. In some embodiments, the system may determine whether it has identified all of the interactive elements placed by a user. If the system determines that there are interactive elements that the system has not yet labeled, the system proceeds to act 1380 where it selects the next interactive element. The system then proceeds to repeat 1340-1350 to identify a location of the selected interactive element and label the interactive element as discussed above. If the system determines that all interactive elements have been labeled, process 1300 ends.

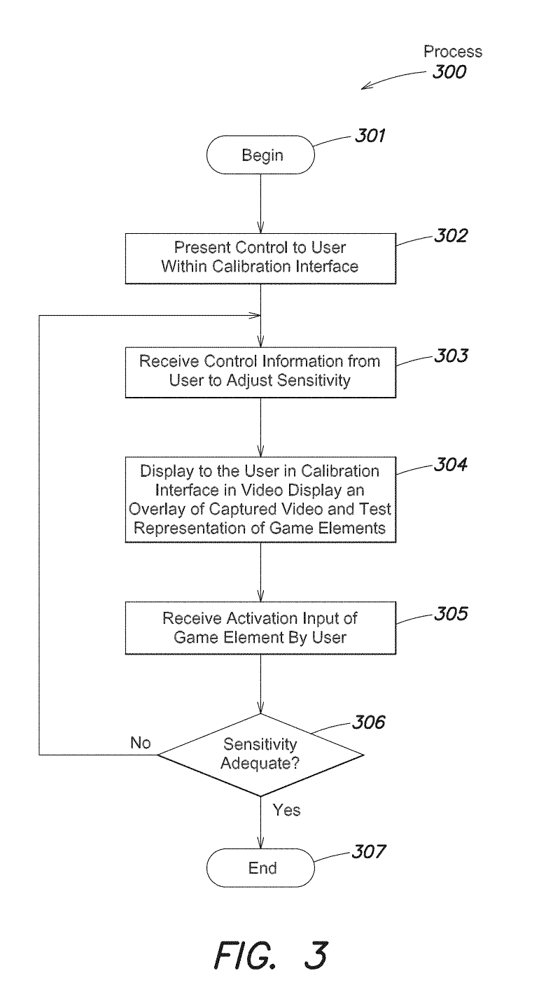

FIG. 3 shows an example process 300 for calibrating an interactive system according to one embodiment of the present invention. At block 301, process 300 begins. At block 302, the system (e.g., end-user system 108) presents a control to the user within a calibration interface. For instance, because the camera, computer system, and projector are not tightly coupled, calibration interface is provided to adjust collection of inputs captured by the video camera in front of the information displayed by the projector. According to one implementation, both the camera and projector are pointed to the same general area, and the system allows for an alignment to interactive display data being projected by the projector and captured image data received from the camera.

Further, at block 303, the system receives control information from the user to adjust the sensitivity. For instance, the system may be adjusted to sense different actions as selection events within the interface. By adjusting the sensitivity to be more sensitive, less action is required on behalf of the user to activate a particular displayed control. In one embodiment, the sensitivity may include the sensitivity of the projected interface control to motion of an image captured by the camera.

At block 304, the system displays to the user within the calibration interface (e.g., in video display 109) and overlay of captured video and a test representation of game elements. For instance, within the calibration display, a number of test controls may be provided that permits the user to adjust an alignment between the controls displayed by the projector and the control inputs as detected by the video camera. According to one embodiment, the system may permit the user to adjust (e.g., by stretching, offsetting, or other adjustment) of an input display definition that defines the control inputs over the actual displayed information by the projector. In this way, the user may adjust the geometry of the control input area, which can be customized to the particular environment. At block 305, the system may receive an activation input of the game elements by user (e.g., for test purposes).

At block 306, it is determined whether the sensitivity is adequate depending on the user input and whether the game element was activated satisfactorily. If not, the user may adjust the sensitivity either up or down accordingly to achieve the desired result. If the sensitivity is deemed adequate at block 306, the process ends at block 307, after which a game may be designed or played.

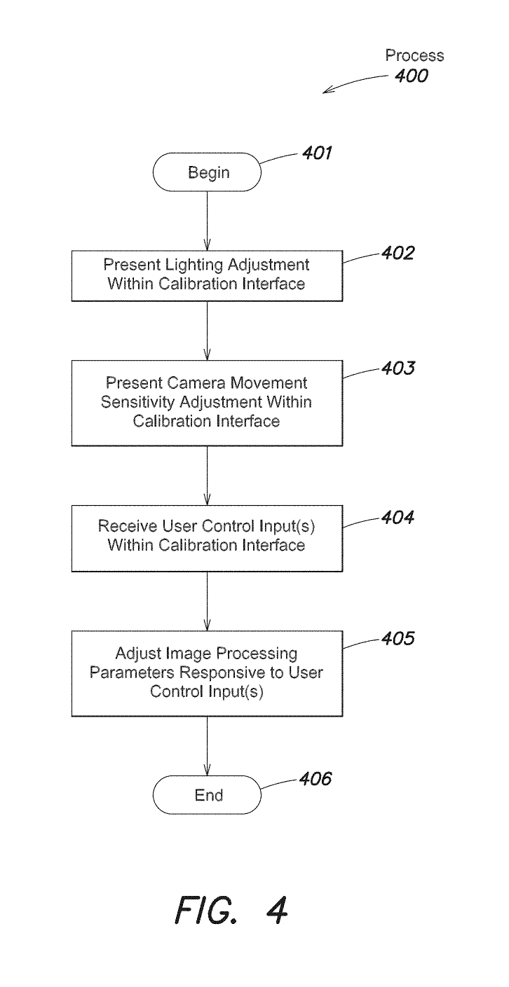

FIG. 4 shows another example process 400 for calibrating an interactive system according to one embodiment of the present invention. At block 401, process 400 begins. At block 402, the system presents a lighting adjustment within the calibration interface. For instance, it is appreciated that depending on the environment, the lighting situation may be various, and therefore it may be useful to present a lighting adjustment that can be adjusted as required by user at the installation location.

At block 403, the system may also present a camera movement sensitivity adjustment within the calibration interface. For instance, the system may be capable of sensing different levels of movement, and depending on the game or other presentation format, it may be desired to change this control. At block 404, the system receives user control inputs within the calibration interface of one or more adjustments. At block 405, the system adjusts image processing parameters responsive to the user control inputs. At block 406, process 400 ends.

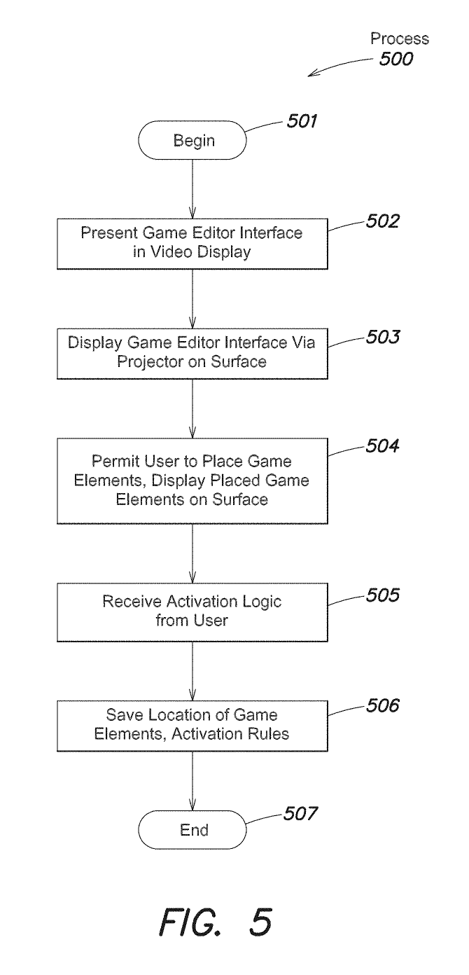

FIG. 5 shows an example process 500 for designing a game using an interactive system according to one embodiment of the present invention. At block 501, process 500 begins. At block 502, the system presents game editor interface within a video display of a computer system (e.g., display 109 of end user system 108). In particular, according to one aspect, a user is permitted to create various instantiations of an interactive game (or other interactive display) within an editor interface. Within this editor, the user is permitted to drag-and-drop particular game elements, define behavior of the game responsive to particular inputs, and align particular game elements with real world entities. In the case of a climbing game, certain game elements may be aligned to areas in the real world such as a climbing hold or other element of achievement.

At block 503, the system displays game editor interface via the projector on a surface. In one embodiment, the surface is a wall surface such as a climbing area within a climbing gym. At block 504, the system permits the user to place game elements, and display those placed game elements on the surface. As discussed above, game elements may be placed over particular hold locations in a climbing game.

At block 505, the system receives activation logic from a user. For instance, the system may require that the user activate a particular control for a certain amount of time. Also, particular game elements may have certain behaviors, when activated. At block 506, the system sees the location of one or more game elements, and their associated activation rules. For example, such information may be stored in a distributed system (e.g., distributed system 100) as a game definition that can be executed by one or more computer systems. In one embodiment, a number of predetermined games may be defined and played at a number of different locations. At block 507, process 500 ends.

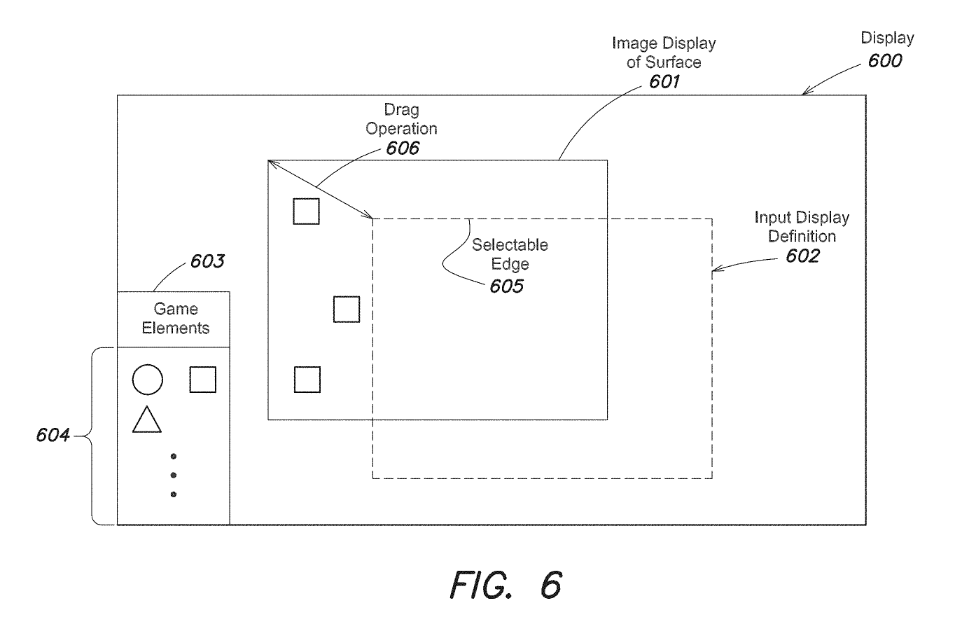

FIG. 6 shows an example user interface according to various embodiments of the present invention. In particular, FIG. 6 shows a display 600 that may be provided on a computer system at a customer site (e.g., end-user system 108). Display 600 may include a number of images that permit the user to calibrating an interactive system, design games or other game content, and/or any other type of interactive content.

In particular, display 600 may include an image display of the surface 601. This image may be a displayed video image of the real world surface (e.g., a wall) that is being captured currently using the camera (e.g., a web cam coupled to the computer system). Display 600 may also include an input display definition 602 in which are detected interactions. Also, within the input display definition 602, one or more game elements (e.g., 603) may be provided in place by user to correspond with detected areas within the real world (e.g., detecting interactions along the surface of a wall).

Game elements 603 may include one or more different types of elements 604. These different types of elements may exhibit different behaviors and/or have different activation logic associated with them. The user may selectively place different types of elements to create a particular game and/or interactive content. According to one embodiment, in one operation, the user may be permitted to move the input display definition 602 to align with an image display of the surface (e.g., 601). The user may use a pointing device to “grab” a selectable edge 605 which can be used to reposition input display definition 602 using a drag operation 606. In this way, the input display definition 602 may be aligned with an image display of the surface 601. However, it should be appreciated that other input types may be used to reposition input display definition 602 (e.g., a keyboard input, programmatic input, other physical control input, etc.).

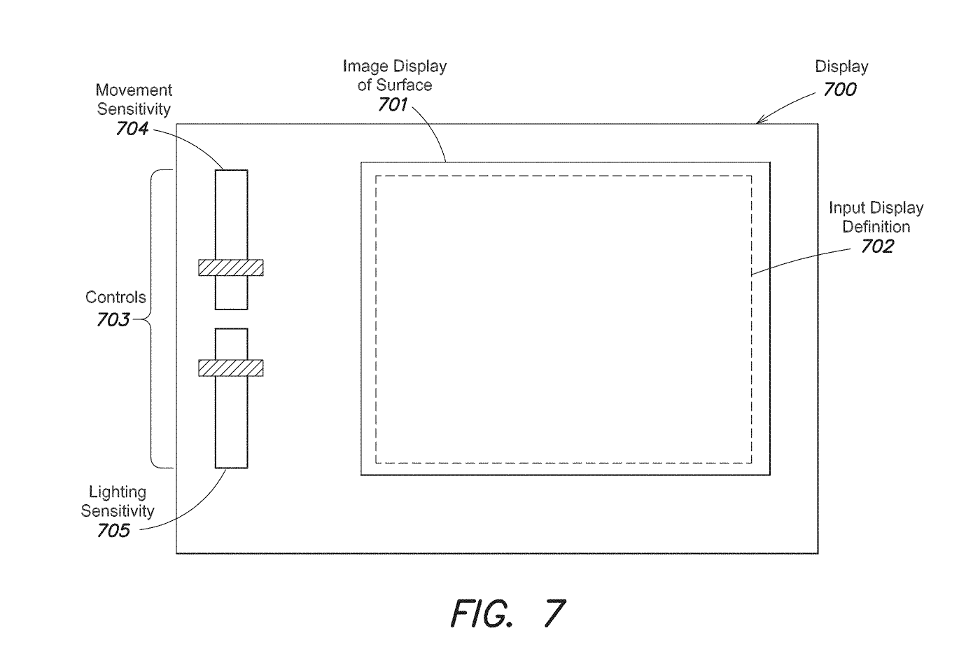

FIG. 7 shows an example user interface with various user controls according to various embodiments of the present invention. As discussed above, because there may be a variety of public display areas, applications, and possible games or interactive content that may be used with the system, a number of controls (e.g., controls 703 may be provided to account for differences within the environment and application. To this end, a display 700 may be provided on a local computer system (e.g., end-user system 108) that permits the user to adjust particular aspects of how the captured images are processed.

For example, display 700 may include an image display of a surface 700 and an input display definition 702 similar to those as discussed above with reference to FIG. 6. Display 700 may also include one or more control, 703 that compensate for movement and lighting. For example, display 700 may include a movement sensitivity control 704 that compensates for movement within the display. Such movements may be used to determine whether a particular element is activated (or not) based on the movement type. If set to a lower sensitivity, smaller movements such as those by the hand may be used to activate a particular game element or other interactive element type. If set to a high sensitivity, it may take more interaction with the game element to cause particular game element to be activated (e.g., a length or duration of activation). Display 700 may also include the lighting sensitivity control 705 which can be used to compensate for actual lighting conditions at the customer site location. For instance, if dimly lit, activation of particular elements may not be detected. Therefore, the user may adjust the lighting sensitivity control to more adequately detect activations of certain elements within various environments.

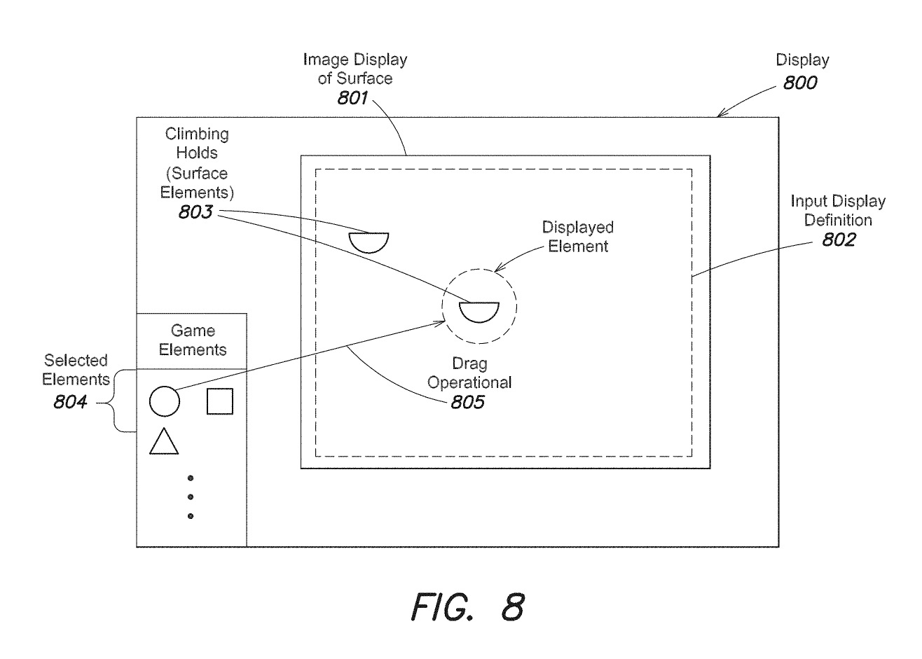

FIG. 8 shows an example user interface used to design an interactive game according to various embodiments of the present invention. In particular, FIG. 8 shows a display 800 that includes controls that permit the user to design interactive content according to various aspects. In particular, display 800 includes an image display of a surface 801, as discussed above with reference to FIGS. 6 and 7. In one embodiment, a climbing game may be designed by a user at a customer site such as a climbing gym. In particular, there may be one or more surface elements (e.g., climbing holds) that are positioned long the surface where the interactive content will be displayed. For instance, one or more climbing holds 803 may be positioned along the wall, and the video capture of the image display of the surface it 801 may show those surface elements within display 800. The user may be permitted to define one or more game elements which are co-located with the surface elements within the display. In one embodiment, the user may select one or more elements 804 and, using a drag operation 805, position one or more elements within the display 800. In particular, the user may place a displayed element within the input display definition 802. In one embodiment, the interface may allow for calibrating moving surface elements by allowing the user to define the path of the moving element by mouse dragging or other method.

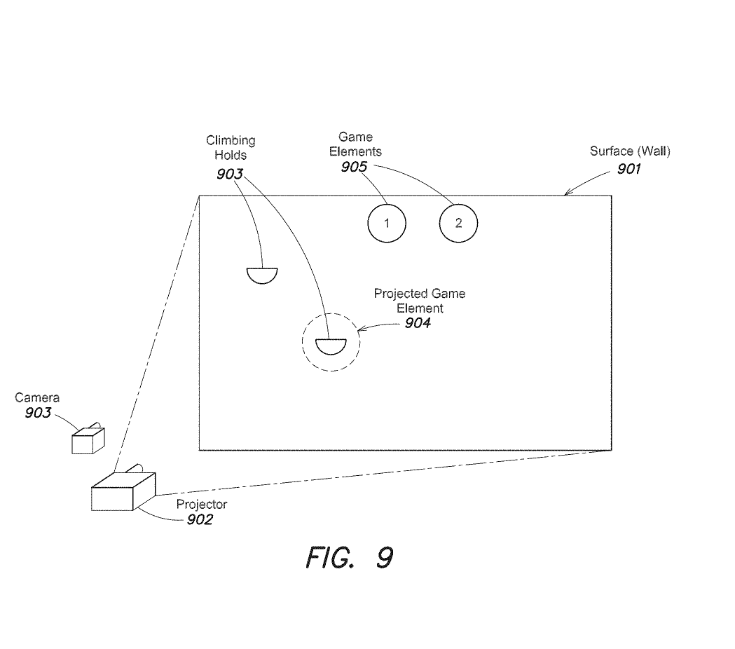

FIG. 9 shows an example user interface used to present an interactive game according to various embodiments of the present invention. In particular, FIG. 9 shows a surface 901 on which is displayed in interactive game using a standard projector 902 and camera 903 integrated with the computer system (not shown). In particular, projector 902 projects interactive content on a surface such as a wall. In one embodiment, the interactive content is a game that is integrated with a climbing gym and wall having one or more climbing holds 903 on which is projected at least one game element (e.g. projected game element 904). The wall may include other game elements displayed on the wall such as game elements 905. In one particular game format, the game requires that certain elements are activated in particular order, therefore, elements have indications identifying which order each elementary activated (e.g., by a climber/user). It should be appreciated that other types of games or interactive content may be used and various aspects of the invention may be implemented in other formats.

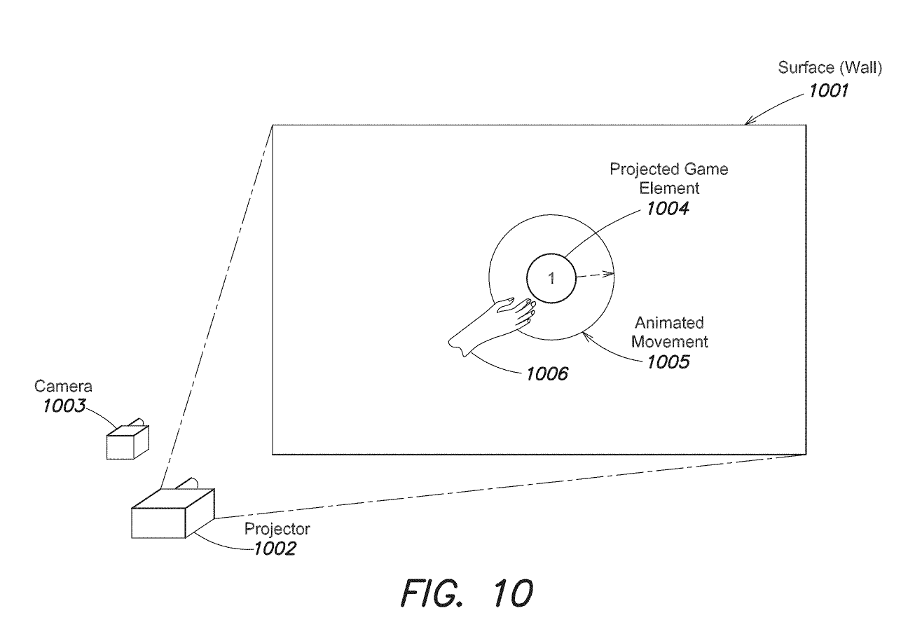

FIG. 10 shows an example user interface that shows an interactive game element according to various embodiments of the present invention. In particular, FIG. 10 shows a surface 1001 on which is displayed interactive content. In one embodiment, the projector 1002 projects a projected game element 1004 that exhibits particular behaviors. When activated by, for example, the user (e.g., by user's hand 1006), the projected game element 1004 may expand responsive to a desired act division by the user and an animated movement of the game element may be shown to the user. For example, when the user places his/her hand on the projected game element, the game element may expand and animate outwards, growing in size until fully activated. For example, projected game element 1004 may expand to an outward size associated with animated movement 1005. In this way, feedback is visually provided to the user as they interact with the game, and the interactive content/game is more easily manipulated by a user.

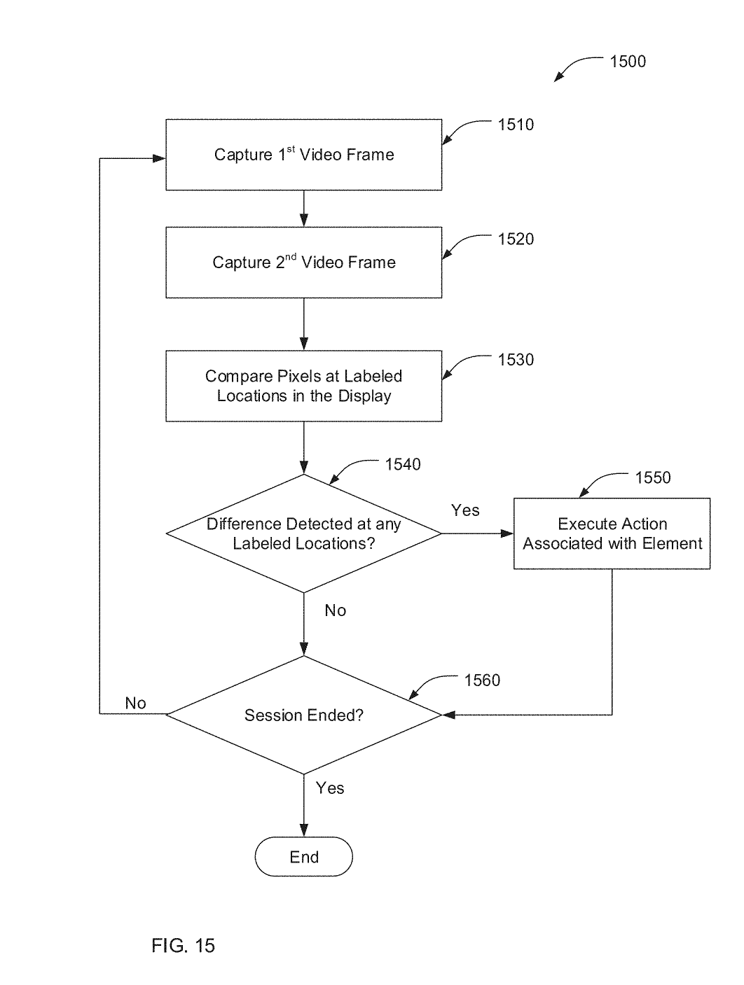

FIG. 15 illustrates an exemplary process 1500 for detecting user interaction with interactive content (e.g., during a game) according to some embodiments. Process 1500 may be executed system 1100 described above with respect to FIG. 11.

Exemplary process 1500 begins at act 1510, where the system captures a first image frame. In some embodiments, interactive processing system 1110 may instruct image capture device 1140 (e.g., a digital camera) to capture video. The interactive processing system 1110 may then capture the first frame from the received video data. In some embodiments, the digital camera may be configured to constantly capture video information and transmit it to interactive processing system 1110. Interactive processing system 1110 may capture the first frame from the received video information. In some embodiments, the system 1110 may combine more than one image frame to form the first frame (e.g., by integrating more than one video frame).

Next, process 1500 proceeds to act 1520, where the system 1100 captures a second image frame. In some embodiments, the interactive processing system 1110 may capture a second frame from the video information received from the image capture device 1140. The interactive processing system 1110 may, for example, capture image frames from the video information at a certain frequency (e.g., every 1 ms). The interactive processing system 1110 may capture the second image frame after capturing the first image frame. In some embodiments, the interactive processing system 1110 may integrate more than one frame after the first image frame to capture the second image frame.

Next, process 1500 proceeds to act 1530, where the interactive processing system 1110 compares pixel values between the first image frame and the second image frame. The system 1110 may, for example, determine a difference between RGB pixel intensity values between pixels of the first image frame and pixels of the second image frame. In some embodiments, the system 1110 may be configured to only compare pixel values at labeled locations corresponding to locations of interactive display elements within the image. The system 1110 may, for example, have the labeled locations stored as a result of executing setup and/or labeling process 1300 described above. The inventors have appreciated that limiting computation of differences in image pixel values at specific labeled locations may significantly reduce computations required for interactive processing.

In one example, the first image frame may comprise an image captured at a first time at which there was no user interaction. The second image frame may comprise an image captured at a second time at which there is a user interaction present. The user interaction may, for example, comprise a user's hand or other body part placed at or near an interactive element. The system 1110 may then detect a difference in pixel values at the labeled location in the images corresponding to the interactive element that the user interacted with (e.g., the first image frame has no hand and the second image frame has a hand). In another example, there may be no user interaction with any interactive elements. In this case the first and second image frames may have substantially equal pixel values at the labeled location(s) corresponding to the interactive display element(s).

Next, process 1500 proceeds to act 1540 where the system 1110 determines whether there is a difference in pixel values at labeled locations within the image. In some embodiments, the system 1110 may determine whether the difference(s) between the pixel values of the first and second image frames at the labeled locations exceed a threshold. In some embodiments, the system 1110 may detect a user interaction at a labeled location responsive to determining that the difference in pixel values exceeds the threshold difference at the labeled location. If the system 1110 determines that the difference in pixel values does not exceed the threshold, the system 1110 may determine that the images are substantially the same and there is no user interactions present.

For example, the first image frame can comprise an image of the display surface 1130 without any user interaction at any labeled interactive element location and the second image frame can comprise an image with a user interaction at a labeled interactive element location (e.g., a user's hand at the interactive element location within the image). In this case, the system 1110 may detect a difference in pixel values at the labeled location that exceeds a set threshold for user interaction detection. In another example, both the first and second image frames may comprise images without any user interaction present. In this case, the system 1110 may determine that a difference between pixel values of the two image frames at the labeled locations does not exceed the threshold for user interaction detection.

If the system 1110 determine that there is a difference 1540, YES, process 1500 proceeds to act 1550 where the system 1110 executes an action associated with the user interaction. In some embodiments, the action may comprise an indication to the user of the interaction (e.g., an animation or other display). For example, the interactive element may comprise a game element and the system 1110 may animate the interactive element display and other portions of the display responsive to a detected user interaction. In another example, the interactive element may comprise a game element and the system 1110 may trigger a game action (e.g., scoring) responsive to detecting a user interaction. The system 1110 can be configured to execute any action responsive to the detection as embodiments are not limited in this respect.

If the system 1110 determines that there is not a difference between the first and second image frames 1540, YES or the system 1110 has completed an action associated with a detected difference at act 1550, process 1500 proceeds to act 1560 where the system 1110 determines whether a session has ended. For example, the session may comprise a game session and the system may determine 1110 that the game has ended. For example, the system 1110 may detect an end to a game responsive to expiration of a time or detection that a particular score has been reached. In some embodiments, the system 1110 may detect an end to a game responsive to detecting one or more user interactions. If the system 1110 determines that the session has ended 1560, YES, process 1560 ends. If the system 1110 determines that the session has not ended 1560, NO, process 1500 proceeds to act 1510 where it continues executing steps to determine user interactions and execute actions accordingly.

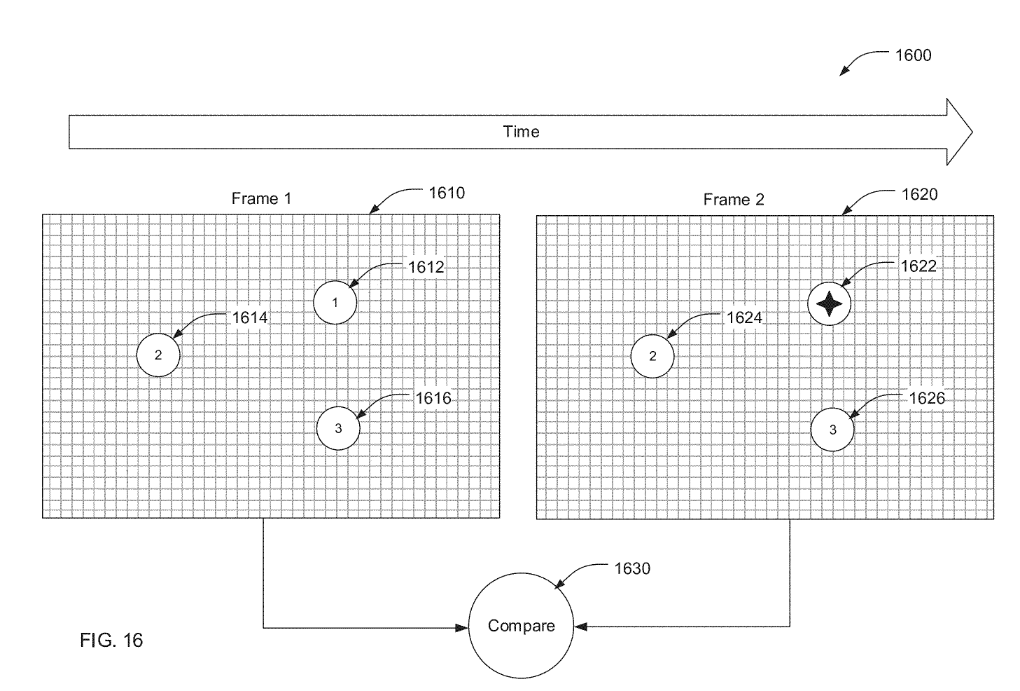

FIG. 16 illustrates an example process of capturing and comparing images (e.g., carried out during process 1500 described above). The interactive system 1100 may capture a first image frame 1610 at a first point in time in which there is not user interaction with any interactive elements. The image frame may include displays of interactive elements 1612, 1614, 1616 without any change in the images as originally configured during game setup. At a second point in time later than the first point, a user may interact with one of the interactive elements. The interactive system 1100 may capture an image of this interaction in a second image frame 1620. The second image frame may include a display of the user interaction with one of the interactive elements 1622. The display may, for example, include a picture of a hand or other user body part within a window of pixels that includes the display of interactive element 1622. The window may, for example, have been defined during process 1300 described above.

The interactive processing system 1110 may then compare 1630 the first image frame 1610 to the second image frame 1620. In some embodiments, the interactive processing system 1110 may compute differences in pixels in the window of pixels associated with each interactive element. The interactive processing system 1110 may detect a difference in pixels of interactive element 1 between pixels of the first image frame 1612 and those of the second image frame 1622. In one example, the interactive processing system 1110 detects that a difference in pixel intensity values of the two images exceeds a threshold at those pixels. In response, the interactive processing system 1110 may trigger a defined (e.g., programmed and/or stored) action responsive to the detecting. For example, the interactive processing system 1110 may trigger scoring action in a game, trigger generation of an animation in the generated display, or other action.

Various aspects and functions described herein may be implemented as specialized hardware or software components executing in one or more specialized computer systems. There are many examples of computer systems that are currently in use that could be specially programmed or specially configured. These examples include, among others, network appliances, personal computers, workstations, mainframes, networked clients, servers, media servers, application servers, database servers, and web servers. Other examples of computer systems may include mobile computing devices (e.g., smart phones, tablet computers, and personal digital assistants) and network equipment (e.g., load balancers, routers, and switches). Examples of particular models of mobile computing devices include iPhones, iPads, and iPod Touches running iOS operating systems available from Apple, Android devices like Samsung Galaxy Series, LG Nexus, and Motorola Droid X, Blackberry devices available from Blackberry Limited, and Windows Phone devices. Further, aspects may be located on a single computer system or may be distributed among a plurality of computer systems connected to one or more communications networks.

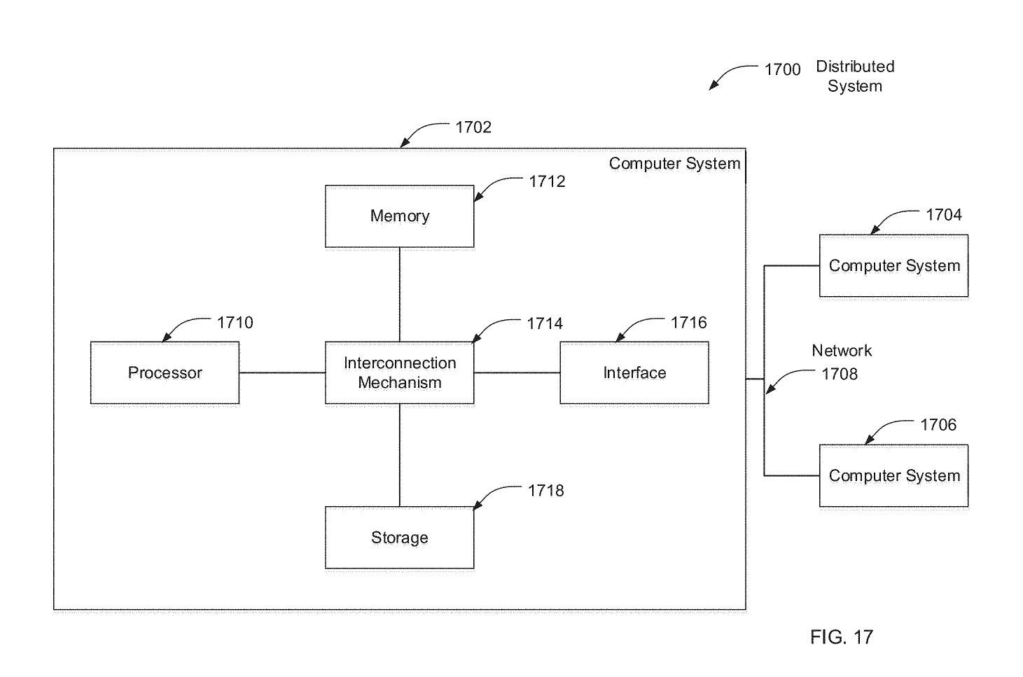

For example, various aspects, functions, and processes may be distributed among one or more computer systems configured to provide a service to one or more client computers, or to perform an overall task as part of a distributed system, such as the distributed computer system 1700 shown in FIG. 17. Additionally, aspects may be performed on a client-server or multi-tier system that includes components distributed among one or more server systems that perform various functions. Consequently, embodiments are not limited to executing on any particular system or group of systems. Further, aspects, functions, and processes may be implemented in software, hardware or firmware, or any combination thereof. Thus, aspects, functions, and processes may be implemented within methods, acts, systems, system elements and components using a variety of hardware and software configurations, and examples are not limited to any particular distributed architecture, network, or communication protocol.

Referring to FIG. 17, there is illustrated a block diagram of a distributed computer system 1700, in which various aspects and functions are practiced. As shown, the distributed computer system 1700 includes one or more computer systems that exchange information. More specifically, the distributed computer system 1700 includes computer systems 1702, 1704, and 1706. As shown, the computer systems 1702, 1704, and 1706 are interconnected by, and may exchange data through, a communication network 1708. The network 1708 may include any communication network through which computer systems may exchange data. To exchange data using the network 1708, the computer systems 1702, 1704, and 1706 and the network 1708 may use various methods, protocols and standards, including, among others, Fiber Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST, and Web Services. To ensure data transfer is secure, the computer systems 1702, 1704, and 1706 may transmit data via the network 1708 using a variety of security measures including, for example, SSL or VPN technologies. While the distributed computer system 1700 illustrates three networked computer systems, the distributed computer system 700 is not so limited and may include any number of computer systems and computing devices, networked using any medium and communication protocol.

As illustrated in FIG. 17, the computer system 1702 includes a processor 1710, a memory 1712, an interconnection element 714, an interface 716 and data storage element 1718. To implement at least some of the aspects, functions, and processes disclosed herein, the processor 1710 performs a series of instructions that result in manipulated data. The processor 1710 may be any type of processor, multiprocessor or controller. Example processors may include a commercially available processor such as an Intel Xeon, Itanium, Core, Celeron, or Pentium processor; an AMD Opteron processor; an Apple A4 or A5 processor; a Sun UltraSPARC processor; an IBM Power5+ processor; an IBM mainframe chip; or a quantum computer. The processor 1710 is connected to other system components, including one or more memory devices 1712, by the interconnection element 1714.

The memory 1712 stores programs (e.g., sequences of instructions coded to be executable by the processor 1710) and data during operation of the computer system 1702. Thus, the memory 1712 may be a relatively high performance, volatile, random access memory such as a dynamic random access memory (“DRAM”) or static memory (“SRAM”). However, the memory 1712 may include any device for storing data, such as a disk drive or other nonvolatile storage device. Various examples may organize the memory 1712 into particularized and, in some cases, unique structures to perform the functions disclosed herein. These data structures may be sized and organized to store values for particular data and types of data.

Components of the computer system 1702 are coupled by an interconnection element such as the interconnection element 1714. The interconnection element 1714 may include any communication coupling between system components such as one or more physical busses in conformance with specialized or standard computing bus technologies such as IDE, SCSI, PCI and InfiniBand. The interconnection element 1714 enables communications, including instructions and data, to be exchanged between system components of the computer system 1702.

The computer system 1702 also includes one or more interface devices 1716 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 702 to exchange information and to communicate with external entities, such as users and other systems.

The data storage element 1718 includes a computer readable and writeable nonvolatile, or non-transitory, data storage medium in which instructions are stored that define a program or other object that is executed by the processor 1710. The data storage element 1718 also may include information that is recorded, on or in, the medium, and that is processed by the processor 1710 during execution of the program. More specifically, the information may be stored in one or more data structures specifically configured to conserve storage space or increase data exchange performance. The instructions may be persistently stored as encoded signals, and the instructions may cause the processor 1710 to perform any of the functions described herein. The medium may, for example, be optical disk, magnetic disk or flash memory, among others. In operation, the processor 1710 or some other controller causes data to be read from the nonvolatile recording medium into another memory, such as the memory 1712, that allows for faster access to the information by the processor 1710 than does the storage medium included in the data storage element 1718. The memory may be located in the data storage element 1718 or in the memory 1712, however, the processor 1710 manipulates the data within the memory, and then copies the data to the storage medium associated with the data storage element 1718 after processing is completed. A variety of components may manage data movement between the storage medium and other memory elements and examples are not limited to particular data management components. Further, examples are not limited to a particular memory system or data storage system.

Although the computer system 1702 is shown by way of example as one type of computer system upon which various aspects and functions may be practiced, aspects and functions are not limited to being implemented on the computer system 702 as shown in FIG. 17. Various aspects and functions may be practiced on one or more computers having a different architectures or components than that shown in FIG. 17. For instance, the computer system 1702 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 1702 may be a computer system including an operating system that manages at least a portion of the hardware elements included in the computer system 1702. In some examples, a processor or controller, such as the processor 1710, executes an operating system. Examples of a particular operating system that may be executed include a Windows-based operating system, such as, the Windows-based operating systems, available from the Microsoft Corporation, a MAC OS System X operating system or an iOS operating system available from Apple Computer, one of many Linux-based operating system distributions, for example, the Enterprise Linux operating system available from Red Hat Inc., or a UNIX operating system available from various sources. Many other operating systems may be used, and examples are not limited to any particular operating system.

The processor 1710 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, Java, C++, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

Based on the foregoing disclosure, it should be apparent to one of ordinary skill in the art that the embodiments disclosed herein are not limited to a particular computer system platform, processor, operating system, network, or communication protocol. Also, it should be apparent that the embodiments disclosed herein are not limited to a specific architecture or programming language.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Use of at least one of and a list of elements (e.g., A, B, C) is intended to cover any one selection from A, B, C (e.g., A), any two selections from A, B, C (e.g., A and B), any three selections (e.g., A, B, C), etc., and any multiples of each selection.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system comprising:
a projector;
a camera; and
at least one processor operatively connected to a memory, the at least one processor configured to execute a plurality of system components from the memory, wherein the plurality of system components comprise:
a display component configured to operate the projector to display interactive content on a surface, the interactive content including one or more interactive elements;
a motion capture component configured to operate the camera to capture at least one image of the interactive content displayed by the projector;
an alignment component configured to automatically determine and label locations of the one or more interactive elements in the at least one image of the displayed interactive content; and
a logic management component configured to detect a user interaction with at least one interactive element of the one or more interactive elements.

2. The system according to claim 1, wherein the alignment component is further configured to:
select an interactive element of the one or more interactive elements;
capture a first image, the first image comprising an image of the interactive content without the one or more interactive elements;
capture a second image, the second image comprising an image of the interactive content including only the selected interactive element; and
determine, using the first and second images, a location of the selected interactive element.

3. The system according to claim 2, wherein the alignment component is further configured to:
determine a difference between the first image and the second image;
identify a location where the difference exceeds a threshold; and
label the identified location as the location of the selected interactive element.

4. The system according to claim 3, wherein the alignment component is further configured to determine a difference between pixel values of the first image and the second image to determine the difference.

5. The system according to claim 1, wherein the alignment component is further configured to define a window around a respective location of the at least one interactive element.

6. The system according to claim 5, wherein the alignment component is further configured to define a set of pixels of a captured image as the window.

7. The system according to claim 5, wherein the at least one image includes a plurality of video frames including a first video frame and a second video frame and the motion capture component is further configured to determine, within the defined window, whether a difference between the first video frame and the second video frame exceeds a threshold.

8. The system according to claim 7, wherein the logic management component is configured to:
associate an action with the at least one interactive element;
activate the at least one interactive element; and
command execution of the associated action responsive to the activation.

9. The system according to claim 8, wherein the logic management component is further configured to activate the at least one interactive element responsive to detecting that the difference between the first video frame and the second video frame exceeds the threshold within the defined window.

10. The system according to claim 7, wherein the plurality of system components further includes a control component configured to:
receive a sensitivity input; and
set the threshold according to the sensitivity input.

11. In a system comprising a projector, a camera, and a computer system, a method comprising:
operating the projector to display interactive content on a surface, the interactive content including one or more interactive elements;
operating the camera to capture at least one image of the interactive content displayed by the projector;
automatically determining and labeling, by the computer system, locations of the one or more interactive elements in the at least one image of the displayed interactive content; and
detecting a user interaction with at least one interactive element of the one or more interactive elements.

12. The method according to claim 11, further comprising:
selecting an interactive element of the one or more interactive elements;
capturing a first image, the first image comprising an image of the interactive content without the one or more interactive elements;
capturing a second image, the second image comprising an image of the interactive content including only the selected interactive element; and
determining, using the first and second images, a location of the selected interactive element.

13. The method according to claim 12, further comprising:
determining a difference between the first image and the second image;
identifying a location where the difference exceeds a threshold; and
labeling the identified location as the location of the selected interactive element.

14. The method according to claim 13, further comprising determining a difference between pixel values of the first image and the second image to determine the difference.

15. The method according to claim 11, further comprising defining a window around a respective location of the least one interactive element of the one or more interactive elements.

16. The method according to claim 15, further comprising defining a set of pixels of a captured image as the window.

17. The method according to claim 15, wherein capturing the at least one image includes capturing a plurality of video frames including a first video frame and a second video frame and the method further comprises determining, within the defined window, whether a difference between the first video frame and the second video frame exceeds a threshold.

18. The method according to claim 17, further comprising:
associating an action with the at least one interactive element;
activating the at least one interactive element; and
commanding execution of the associated action responsive to the activation.

19. The method according to claim 18, further comprising activating the at least one interactive element responsive to detecting that the difference between the first video frame and the second video frame exceeds the threshold within the defined window.

20. The method according to claim 17, further comprising:
receiving a sensitivity input; and
setting the threshold according to the sensitivity input.

21. A non-volatile computer-readable medium encoded with instructions for execution on a computer system, the instructions when, executed, perform a method comprising:
operating a projector to display interactive content on a surface, the interactive content including one or more interactive elements;
operating a camera to capture at least one image of the interactive content displayed by the projector;
automatically determining and labeling locations of the one or more interactive elements in the at least one image of the displayed interactive content; and
detecting a user interaction with at least interactive element one of the one or more interactive elements.
